(19) United States
(12) Patent Application Publication
(10) Pub. No.: US 2021/0055725 A1
(43) Pub. Date: Feb. 25, 2021

(54) WIRELESS COMMUNICATION SYSTEM, WIRELESS COMMUNICATION METHOD AND SELF-PROPELLED APPARATUS

(71) Applicant: PEGATRON CORPORATION, Taipei City (TW)

(72) Inventor: Chia-Wei Chen, Taipei City (TW)

(73) Assignee: PEGATRON CORPORATION, TAIPEI CITY (TW)

(21) Appl. No.: 16/993,191

(22) Filed: Aug. 13, 2020

(30) Foreign Application Priority Data
Aug. 23, 2019 (TW) 108130222

(51) Int. Cl. G05D 1/00; G05D 1/02; H04W 72/04; H04W 4/46

(52) U.S. Cl. CPC G05D 1/0027; G05D 1/0022; H04W 4/46; H04W 72/042; G05D 1/0272

(57) ABSTRACT

A wireless communication system, a wireless communication method, and a self-propelled apparatus are provided. The wireless communication system includes a plurality of self-propelled apparatuses. Each of the self-propelled apparatuses is configured to transmit respective moving information and receive moving information of another self-propelled apparatus in the self-propelled apparatuses. At least one of the self-propelled apparatuses forwards the received moving information of another self-propelled apparatus, so that dead spots in the environment in which the self-propelled apparatuses are located are reduced, and a communication distance between the self-propelled apparatuses is expanded.

### CROSS-REFERENCE TO RELATED APPLICATION

This application claims the priority benefit of Taiwan application serial no. 108130222, filed on Aug. 23, 2019. The entirety of the above-mentioned patent application is hereby incorporated by reference herein and made a part of this specification.

### BACKGROUND

### 1. Technical Field

The disclosure relates to a communication technology, and in particular, to a wireless communication system, a wireless communication method, and a self-propelled apparatus.

### 2. Description of Related Art

As technology advances, self-propelled apparatuses have been widely used in various fields, such as self-propelled cleaning apparatuses applied in the field of environment cleaning, self-propelled spraying apparatuses or self-propelled mower apparatuses applied in the field of agriculture, and self-propelled handling apparatuses applied in the field of industry.

Generally speaking, when a plurality of self-propelled apparatuses are present in the environment, each self-propelled apparatus may transmit its own moving information to another self-propelled apparatuses through wireless transmission, so that the self-propelled apparatuses are prevented from colliding with one another. However, communication dead spots may exist between two self-propelled apparatuses in the environment, such that one self-propelled apparatus cannot receive the moving information of the other self-propelled apparatus at the communication dead spots, or the moving information transmitted by one self-propelled apparatus at the communication dead spots cannot be received by the other self-propelled apparatus. As such, communication between these self-propelled apparatuses is affected by the communication dead spots in the environment. In addition, the effective communication distance between these self-propelled apparatuses is restricted since the wireless signal strength may decrease when the transmission distance increases.

### SUMMARY

Accordingly, the disclosure is directed to provide a wireless communication system, a wireless communication method, and a self-propelled apparatus through which communication dead spots in the environment in which self-propelled apparatuses are located are reduced and an effective communication distance between the self-propelled apparatuses is expanded.

A wireless communication system provided by the disclosure includes a plurality of self-propelled apparatuses. Each of the self-propelled apparatuses is configured to transmit respective moving information and receive moving information from other self-propelled apparatuses of the plurality of self-propelled apparatuses. At least one of the self-propelled apparatuses forwards the received moving information of the other self-propelled apparatuses.

A wireless communication method provided by the disclosure is applied to a plurality of self-propelled apparatuses. The wireless communication method includes the following step. By each of the self-propelled apparatuses, respective moving information is transmitted. By each of the self-propelled apparatuses, the moving information of other self-propelled apparatuses in the self-propelled apparatuses is received. By at least one of the self-propelled apparatuses, the received moving information of the other self-propelled apparatuses is forwarded.

A self-propelled apparatus provided by the disclosure includes a wireless communication module and a control circuit. The control circuit is coupled to the wireless communication module, is configured to receive moving information of another self-propelled apparatus through the wireless communication module, and forwards the moving information through the wireless communication module.

Based on the above, by adopting the wireless communication system, the wireless communication method, and the self-propelled apparatus provided by the disclosure, the self-propelled apparatus can forward the received moving information of another self-propelled apparatus. Therefore, the signal dead spots in the environment in which the self-propelled apparatuses are located may be effectively eliminated and the effective communication distance between the self-propelled apparatuses may be expanded.

To make the features and advantages of the disclosure clear and easy to understand, the following gives a detailed description of embodiments with reference to accompanying drawings.

### BRIEF DESCRIPTION OF THE DRAWINGS

The following accompanying drawings are part of the specification of the disclosure, and illustrate exemplary embodiments of the disclosure. The accompanying drawings and the description of the specification jointly explain the principle of the disclosure.

FIG. 1 is a schematic view of a wireless communication system according to an embodiment of the disclosure.

FIG. 2 is a schematic block view of a self-propelled apparatus according to an embodiment of the disclosure.

FIG. 3 is a schematic view of a wireless communication system according to another embodiment of the disclosure.

FIG. 4 is a schematic flow chart of a wireless communication method according to an embodiment of the disclosure.

FIG. 5 is a schematic flow chart of a wireless communication method according to another embodiment of the disclosure.

### DESCRIPTION OF THE EMBODIMENTS

To make the content of the disclosure more comprehensible, embodiments are described below as examples according to which the disclosure can indeed be implemented. Wherever possible, the same reference numbers are used in the drawings and the implementations to refer to the same or like parts or components.

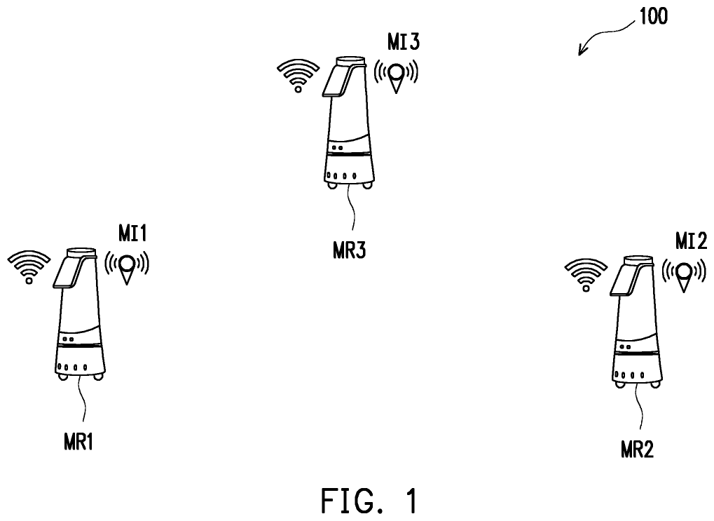

FIG. 1 is a schematic view of a wireless communication system according to an embodiment of the disclosure. Referring to FIG. 1, a wireless communication system 100 may include a plurality of self-propelled apparatuses. However, for the convenience in description and the simplicity in illustration, the present embodiment is described by taking three self-propelled apparatuses MR1, MR2, and MR3 as an example. Embodiments involving two or more than four (included) self-propelled apparatuses may be deduced by analogy according to the following description.

In one embodiment of the disclosure, each of the self-propelled apparatuses MR1, MR2, and MR3 may be, for example, a self-propelled guide apparatus, a self-propelled cleaning apparatus, a self-propelled spraying apparatus, a self-propelled mower apparatus or a self-propelled handling apparatus, but is not limited thereto.

Each of the self-propelled apparatuses MR1, MR2, and MR3 is used to transmit respective moving information and receive the moving information of other self-propelled apparatuses of the self-propelled apparatuses MR1, MR2, and MR3. In detail, the self-propelled apparatus MR1 may periodically transmit its own moving information MI1, the self-propelled apparatus MR2 may periodically transmit its own moving information MI2, and the self-propelled apparatus MR3 may periodically transmit its own moving information MI3. In addition, the self-propelled apparatus MR1 may receive the moving information MI2 of the self-propelled apparatus MR2, the self-propelled apparatus MR1 may also receive the moving information MI3 of the self-propelled apparatus MR3, the self-propelled apparatus MR2 may receive the moving information MI1 of the self-propelled apparatus MR1, the self-propelled apparatus MR2 may also receive the moving information MI3 of the self-propelled apparatus MR3, the self-propelled apparatus MR3 may receive the moving information MI1 of the self-propelled apparatus MR1, and the self-propelled apparatus MR3 may also receive the moving information MI2 of the self-propelled apparatus MR2.

In particular, at least one of the self-propelled apparatuses MR1, MR2, and MR3 may forward the received moving information of other self-propelled apparatuses. For example, the self-propelled apparatus MR1 may forward the received moving information MI2 and/or MI3 of the self-propelled apparatus MR2 and/or MR3. Similarly, the self-propelled apparatus MR2 may forward the received moving information MI1 and/or MI3 of the self-propelled apparatus MR1 and/or MR3. By analogy, the self-propelled apparatus MR3 may forward the received moving information MI1 and/or MI2 of the self-propelled apparatus MR1 and/or MR2.

In other words, at least one of the self-propelled apparatuses MR1, MR2, and MR3 may be used as a message relay in the wireless communication system 100, so as to forward (i.e., retransmit) the received moving information of the other self-propelled apparatuses. Therefore, the signal dead spots in the environment in which the self-propelled apparatuses MR1, MR2, and MR3 are located can be effectively eliminated, and the effective communication distances among the self-propelled apparatuses MR1, MR2, and MR3 can be expanded.

For example, as illustrated in FIG. 1, the self-propelled apparatus MR3 may not only transmit its own moving information MI3, but also serves as a message relay for the self-propelled apparatus MR1 and the self-propelled apparatus MR2 to forward the received moving information MI1 and/or MI2 of the self-propelled apparatus MR1 and/or MR2, such that the self-propelled apparatus MR2 and/or MR1 can receive the moving information MI1 and/or MI2 forwarded by the self-propelled apparatus MR3. Therefore, even if the distance between the self-propelled apparatus MR1 and the self-propelled apparatus MR2 is too long or there is a signal shield such that the moving information transmitted by the other self-propelled apparatus cannot be directly received, the self-propelled apparatus MR1 (MR2) can still indirectly obtain the moving information MI2 (MI1) of the self-propelled apparatus MR2 (MR1) through the self-propelled apparatus MR3.

In one embodiment of the disclosure, each of the self-propelled apparatuses MR1, MR2, and MR3 includes a client mode and an access point (AP) mode. Each of the self-propelled apparatuses MR1, MR2, and MR3 may broadcast their own moving information through the access point mode and receive the moving information of other self-propelled apparatuses of the self-propelled apparatuses MR1, MR2, and MR3 through the client mode. In addition, at least one of the self-propelled apparatuses MR1, MR2, and MR3 may rebroadcast the received moving information of the other self-propelled apparatuses through the access point mode.

In one embodiment of the disclosure, each of the self-propelled apparatuses MR1, MR2, and MR3 may calculate the distance to another self-propelled apparatus according to the respective moving information and the received moving information of the another self-propelled apparatus, and adjust their own moving speed and direction according to the calculated distance. For example, the self-propelled apparatus MR1 may calculate the distance to the self-propelled apparatus MR2 according to its own moving information MI1 and the received moving information MI2 of the self-propelled apparatus MR2, and the self-propelled apparatus MR1 may adjust its own moving speed and direction according to this distance to avoid collision with the self-propelled apparatus MR2. Similarly, the self-propelled apparatus MR1 may calculate the distance to the self-propelled apparatus MR3 according to its own moving information MI1 and the received moving information MI3 of the self-propelled apparatus MR3, and the self-propelled apparatus MR1 may adjust its own moving speed and direction according to this distance to avoid collision with the self-propelled apparatus MR3. Similarly, the operation of the self-propelled apparatuses MR2, MR3 may be deduced by analogy.

In one embodiment of the disclosure, the moving information MI1 of the self-propelled apparatus MR1 may include a position message, a speed message, a direction message and the number of forwarding times of the moving information MI1 of the self-propelled apparatus MR1. Similarly, the moving information MI2 of the self-propelled apparatus MR2 may include a position message, a speed message, a direction message and the number of forwarding times of the moving information MI2 of the self-propelled apparatus MR2. By analogy, the moving information MI3 of the self-propelled apparatus MR3 may include a position message, a speed message, a direction message and the number of forwarding times of the moving information MI3 of the self-propelled apparatus MR3.

In one embodiment of the disclosure, if the number of forwarding times in the moving information MI2 (MI3) received by the self-propelled apparatus MR1 does not reach a reference number of times, the self-propelled apparatus MR1 may update the number of forwarding times in the received moving information MI2 (MI3), and forward the updated moving information MI2 (MI3). In contrast, if the number of forwarding times in the moving information MI2 (MI3) received by the self-propelled apparatus MR1 reaches the reference number of times, it indicates that the moving information MI2 (MI3) is useless or outdated, so the self-propelled apparatus MR1 does not forward the moving information MI2 (MI3), so as to prevent the wireless communication system 100 from being full of useless or outdated moving information. Similarly, the operation of the self-propelled apparatuses MR2, MR3 may be deduced by analogy.

For example, when the self-propelled apparatus MR1 transmits the moving information MI1, the self-propelled apparatus MR1 may reset the number of forwarding times of the moving information MI1 to zero. Similarly, when the self-propelled apparatus MR2 (MR3) transmits the moving information MI2 (MI3), the self-propelled apparatus MR2 (MR3) may reset the number of forwarding times of the moving information MI2 (MI3) to zero. When the self-propelled apparatus MR1 receives the moving information MI2 (MI3), the self-propelled apparatus MR1 may check whether the number of forwarding times in the moving information MI2 (MI3) reaches a reference number of times (for example, but not limited to, three times).

If the number of forwarding times in the moving information MI2 (MI3) received by the self-propelled apparatus MR1 does not reach the reference number of times, the self-propelled apparatus MR1 may add one to the number of forwarding times in the received moving information MI2 (MI3) to update the moving information MI2 (MI3), and forward the updated moving information MI2 (MI3). In contrast, if the number of forwarding times in the moving information MI2 (MI3) received by the self-propelled apparatus MR1 reaches the reference number of times, the self-propelled apparatus MR1 does not forward the moving information MI2 (MI3).

Alternatively, when the self-propelled apparatus MR1 transmits the moving information MI1, the self-propelled apparatus MR1 may set the number of forwarding times in the moving information MI1 as a reference number of times (for example, but not limited to, three times). Similarly, when the self-propelled apparatus MR2 (MR3) transmits the moving information MI2 (MI3), the self-propelled apparatus MR2 (MR3) may set the number of forwarding times in the moving information MI2 (MI3) as a reference number of times. When the self-propelled apparatus MR1 receives the moving information MI2 (MI3), the self-propelled apparatus MR1 may check whether the number of forwarding times in the moving information MI2 (MI3) are equal to zero. If the number of forwarding times in the moving information MI2 (MI3) received by self-propelled apparatus MR1 are not equal to zero, the self-propelled apparatus MR1 may subtract one from the number of forwarding times in the received moving information MI2 (MI3) to update the moving information MI2 (MI3), and forward the updated moving information MI2 (MI3). In contrast, if the number of forwarding times in the moving information MI2 (MI3) received by the self-propelled apparatus MR1 are equal to zero, the self-propelled apparatus MR1 does not forward the moving information MI2 (MI3).

In one embodiment of the disclosure, each of the self-propelled apparatuses MR1, MR2, and MR3 may calculate a distance to another self-propelled apparatuses according to the respective moving information and the received moving information of the another self-propelled apparatuses, and adjust a frequency of transmitting the respective moving information to the another self-propelled apparatuses according to the distance.

For example, the self-propelled apparatus MR1 may calculate the distance to the self-propelled apparatus MR3 according to its own moving information MI1 and the received moving information MI3. The self-propelled apparatus MR1 may adjust the frequency of transmitting the moving information MI1 according to the distance to the self-propelled apparatus MR3. When the distance between the self-propelled apparatus MR1 and the self-propelled apparatus MR3 is short, it indicates that the probability of collision between the self-propelled apparatus MR1 and the self-propelled apparatus MR3 is high. Therefore, the self-propelled apparatus MR1 may increase the frequency of transmitting the moving information MI1 (i.e., shorten the period of transmitting the moving information MI1), so as to reduce the error between the moving information MI1 obtained by the self-propelled apparatus MR3 and the current moving information of the self-propelled apparatus MR1. In contrast, when the distance between the self-propelled apparatus MR1 and the self-propelled apparatus MR3 is long, it indicates that the probability of collision between the self-propelled apparatus MR1 and the self-propelled apparatus MR3 is low. Therefore, the self-propelled apparatus MR1 may decrease the frequency of transmitting the moving information MI1 (i.e., lengthen the period of transmitting the moving information MI1), so as to prevent the wireless communication system 100 from being filled with excessive moving information.

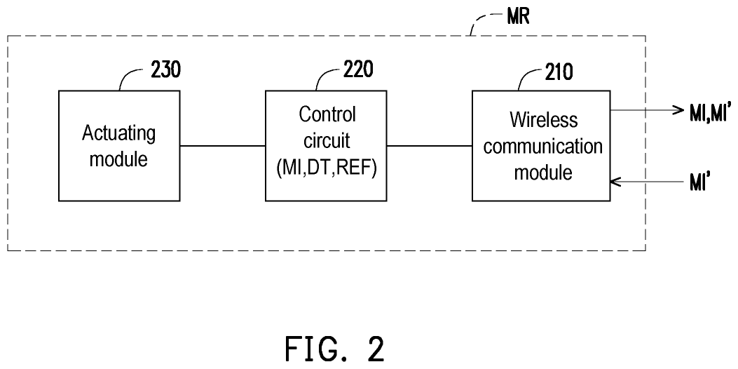

FIG. 2 is a schematic block view of a self-propelled apparatus according to an embodiment of the disclosure, which may serve as the embodiment of the self-propelled apparatuses MR1, MR2, and MR3 in FIG. 1. Referring to FIG. 2, the self-propelled apparatus MR may include, but not limited to, a wireless communication module 210, a control circuit 220 and an actuating module 230. In one embodiment of the disclosure, the wireless communication module 210 includes, but not limited to, a client mode and an access point mode.

The control circuit 220 is coupled with the wireless communication module 210 and the actuating module 230. The control circuit 220 may control the rotation of the actuating module 230, causing the self-propelled apparatus MR to move. The control circuit 220 may detect the position, moving speed and moving direction of the self-propelled apparatus MR to generate the moving information MI of the self-propelled apparatus MR, and transmit (broadcast) the moving information MI of the self-propelled apparatus MR through the access point mode of the wireless communication module 210, wherein the moving information MI may include a position message, a speed message, a direction message and the number of forwarding times of the moving information of the self-propelled apparatus MR. In addition, the control circuit 220 may also receive the moving information MI′ of the other self-propelled apparatuses through the client mode of the wireless communication module 210, and forwards (rebroadcasts) the received moving information MI′ through the access point mode of the wireless communication module 210. The moving information MI′ may include a position message, a speed message, a direction message, and the number of forwarding times of the moving information MI′ of another self-propelled apparatus.

The control circuit 220 may calculate the distance DT to another self-propelled apparatus according to the moving information MI of the self-propelled apparatus MR and the received moving information MI′ of the another self-propelled apparatus. The control circuit 220 may adjust the rotating speed and moving direction of the actuating module 230 according to the distance DT, so as to prevent the self-propelled apparatus MR from colliding with another self-propelled apparatus.

In one embodiment of the disclosure, the control circuit 220 may also adjust the frequency of transmitting the moving information MI to another self-propelled apparatus according to the distance DT between the self-propelled apparatus MR and another self-propelled apparatus. When the distance DT between the self-propelled apparatus MR and another self-propelled apparatus is short, the control circuit 220 may increase the frequency of transmitting the moving information MI to another self-propelled apparatus. In contrast, when the distance DT between the self-propelled apparatus MR and another self-propelled apparatuses is long, the control circuit 220 may decrease the frequency of transmitting the moving information MI to another self-propelled apparatus.

In one embodiment of the disclosure, if the number of forwarding times in the moving information MI′ received by the control circuit 220 does not reach a reference number of times REF, the control circuit 220 may update the number of forwarding times in the moving information MI′ and forward the updated moving information MI′ through the wireless communication module 210. In contrast, if the number of forwarding times in the moving information MI′ received by the control circuit 220 reaches the reference number of times REF, the control circuit 220 does not forward the moving information MI′.

In one embodiment of the disclosure, the control circuit 220 may be hardware, firmware or software or machine-executable program codes stored in a memory and loaded and executed by a processor. If it is implemented by adopting hardware, the control circuit 220 may be implemented by a single integrated circuit chip or by a plurality of circuit chips, but the disclosure is not limited thereto. The plurality of circuit chips or single integrated circuit chip may be implemented by adopting an Application Specific Integrated Circuit (ASIC), a Field Programmable Gate Array (FPGA) or a Complex Programmable Logic Device (CPLD). The memory may be, for example, a Random Access Memory (RAM), a Read-Only Memory (ROM), a flash memory or the like.

In one embodiment of the disclosure, the wireless communication module 210 may be implemented by adopting a Wireless Fidelity (Wi-Fi) module, but the disclosure is not limited thereto. In another embodiment of the disclosure, the wireless communication module 210 may also be implemented by adopting a Bluetooth (BT) module.

In one embodiment of the disclosure, the actuating module 230 may be implemented by adopting various types of motor modules, but the disclosure is not limited thereto.

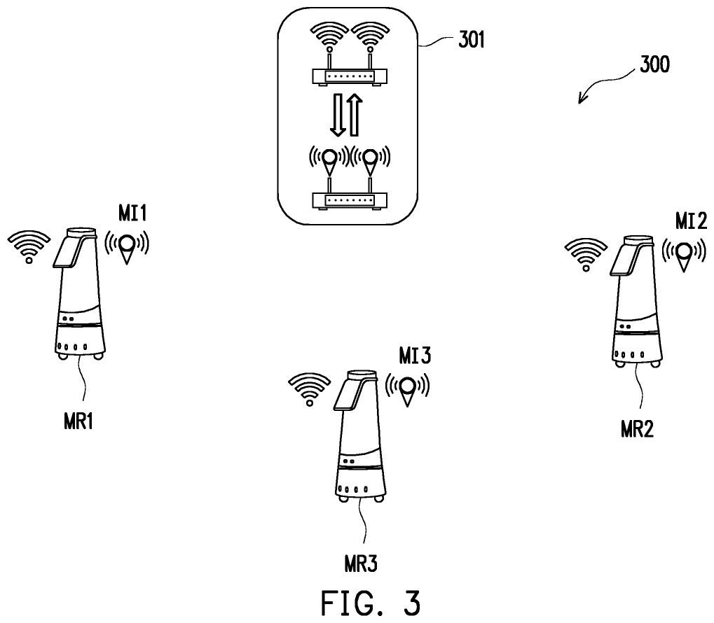

FIG. 3 is a schematic view of a wireless communication system according to another embodiment of the disclosure. Referring to FIG. 3, a wireless communication system 300 may include a plurality of self-propelled apparatuses and at least one Access Point (AP). However, for the convenience in description and the simplicity in illustration, the present embodiment is described by taking three self-propelled apparatuses MR1, MR2, and MR3 and one wireless access point 301 as an example. Embodiments involving two or more than four (included) self-propelled apparatuses and two wireless access points may be deduced by analogy according to the following description.

The implementation mode and operation of the self-propelled apparatuses MR1, MR2, and MR3 in FIG. 3 are respectively similar to that of the self-propelled apparatuses MR1, MR2, and MR3 in FIG. 1. Therefore, a reference may be made to the above related description, so the description thereof is omitted herein. A wireless access point 301 may receive the moving information MI1, MI2, and MI3 of each of the self-propelled apparatuses MR1, MR2, and MR3, and forward the received moving information MI1, MI2, and MI3. In other words, the wireless access point 301 may serve as a message relay in the wireless communication system 300, so as to forward (i.e., retransmit) the received moving information MI1, MI2, and MI3 of the self-propelled apparatuses MR1, MR2, and MR3. Therefore, the signal dead spots in the environment in which the self-propelled apparatuses MR1, MR2, and MR3 are located can be effectively eliminated, and the effective communication distances among the self-propelled apparatuses MR1, MR2, and MR3 can be expanded.

For example, the wireless access point 301 may forward the received moving information MI1 (MI2) of the self-propelled apparatus MR1 (MR2), such that the self-propelled apparatus MR2 (MR1) can receive the moving information MI1 (MI2) forwarded by the wireless access point 301. Therefore, even if the distance between the self-propelled apparatus MR1 and the self-propelled apparatus MR2 is too long or there is a signal shield such that the moving information transmitted by the other self-propelled apparatus cannot be directly received, the self-propelled apparatus MR1 (MR2) can still indirectly obtain the moving information MI2 (MI1) of the self-propelled apparatus MR2 (MR1) through the wireless access point 301.

In one embodiment of the disclosure, the wireless access point 301 may also include a client mode and an access point mode. The wireless access point 301 may receive the moving information MI1, MI2, and MI3 of each of the self-propelled apparatuses MR1, MR2, and MR3 through the client mode, and forward (rebroadcast) the received moving information MI1, MI2, and MI3 through the access point mode.

In one embodiment of the disclosure, if the number of forwarding times in the moving information MI1 received by the wireless access point 301 does not reach a reference number of times, the wireless access point 301 may update the number of forwarding times in the received moving information MI1, and forward the updated moving information MI1. In contrast, if the number of forwarding times of the moving information MI1 received by the wireless access point 301 reaches the reference number of times, it indicates that the moving information MI1 is useless or outdated, so the wireless access point 301 does not forward the moving information MI1, so as to prevent the wireless communication system 300 from being full of useless or outdated moving information. In addition, whether the wireless access point 301 forwards the received moving information MI2 (MI3) may also be deduced by analogy, so the description thereof is omitted herein.

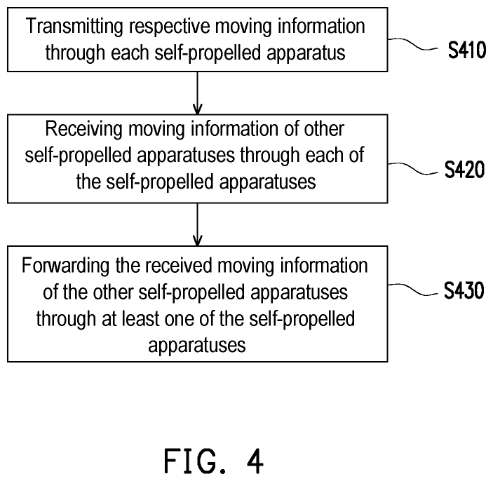

FIG. 4 is a schematic flow chart of a wireless communication method according to an embodiment of the disclosure, which may be applied to, but not limited to, the wireless communication system 100 in FIG. 1 or the wireless communication system 300 in FIG. 3. Referring to FIG. 1 and FIG. 4 together, the wireless communication method provided by the present exemplary embodiment includes the following steps. First, in step S410, each of self-propelled apparatuses MR1, MR2, and MR3 transmits respective moving information MI1, MI2, and MI3. Next, in step S420, each of the self-propelled apparatuses MI1, MI2, and MI3 receives moving information of other self-propelled apparatuses of the self-propelled apparatuses MR1, MR2, and MR3. Then, in step S430, at least one of the self-propelled apparatuses MI1, MI2, and MI3 forwards the received moving information of the other self-propelled apparatuses.

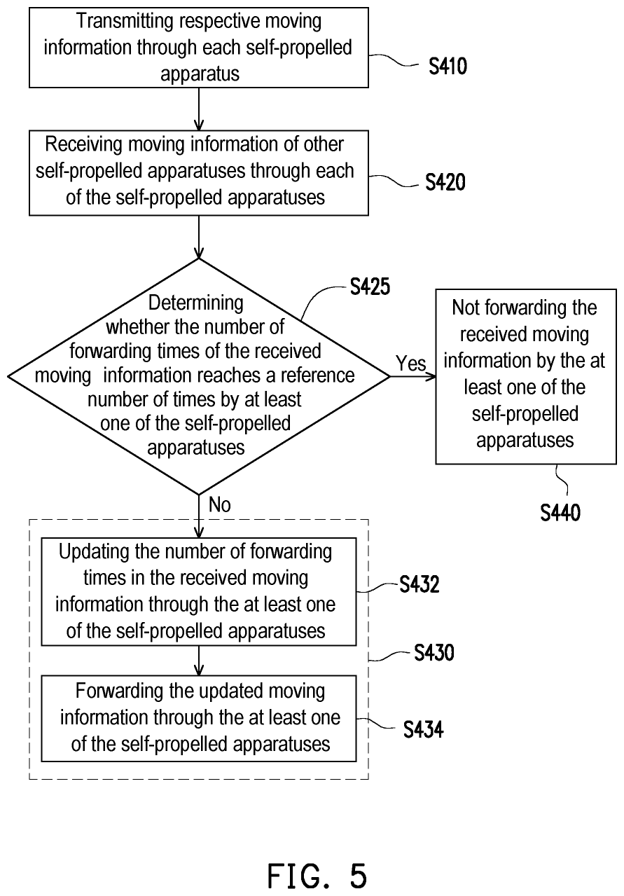

FIG. 5 is a schematic flow chart of a wireless communication method according to another embodiment of the disclosure, which may be applied to, but not limited to, the wireless communication system 100 in FIG. 1 or the wireless communication system 300 in FIG. 3. Referring to FIG. 1 and FIG. 5 together, the wireless communication method provided by the present exemplary embodiment includes the following steps. First, in step S410, each of self-propelled apparatuses MR1, MR2, and MR3 transmits respective moving information MI1, MI2, and MI3. Next, in step S420, each of the self-propelled apparatuses MI1, MI2, and MI3 receives moving information of other self-propelled apparatuses of the self-propelled apparatuses MR1, MR2, and MR3. Then, in step S425, at least one of the self-propelled apparatuses MI1, MI2, and MI3 determines whether the number of forwarding times of the received moving information reaches a reference number of times.

If yes is determined in step S425, then in step S440, the at least one of the self-propelled apparatuses does not forward the received moving information. In contrast, if no is determined in step S425, then in step S430, the at least one of the self-propelled apparatuses forwards the received moving information of another self-propelled apparatus.

Further, step S430 may include detailed steps S432 and S434. In step S432, the at least one self-propelled apparatus updates the number of forwarding times in the received moving information. Next, in step S434, the at least one self-propelled apparatus forwards the updated moving information.

In addition, sufficient teachings, suggestions, and implementation description for the wireless communication method provided by the embodiment of the disclosure may be obtained e from the description provided in the embodiments of in FIG. 1 to FIG. 3, so the description thereof is omitted herein.

In conclusion, in the wireless communication system, the wireless communication method, and the self-propelled apparatus provided by the embodiments of the disclosure, the self-propelled apparatus may forward the received moving information of other self-propelled apparatuses, or the wireless access point may forward the received moving information of the self-propelled apparatus. Therefore, the signal dead spots in the environment in which the self-propelled apparatuses are located can be effectively eliminated and the effective communication distance between the self-propelled apparatuses can be expanded. In addition, if the number of forwarding times of the moving information received by the self-propelled apparatus or the wireless access point reaches the reference number of times, the self-propelled apparatus or the wireless access point does not forward the moving information, so as to prevent the wireless communication system from being filled with useless or outdated moving information. In addition, the self-propelled apparatus may adjust the frequency of transmitting its own moving information according to the distance to another self-propelled apparatus.

Although the disclosure is described with reference to the above embodiments, the embodiments are not intended to limit the disclosure. A person of ordinary skill in the art may make variations and modifications without departing from the spirit and scope of the disclosure. Therefore, the protection scope of the disclosure should be subject to the appended claims.

What is claimed is:

1. A wireless communication system, comprising:
a plurality of self-propelled apparatuses, each of the self-propelled apparatuses being configured to transmit respective moving information and receive moving information from other self-propelled apparatuses of the plurality of self-propelled apparatuses,
wherein at least one of the self-propelled apparatuses forwards the received moving information of the other self-propelled apparatuses.

2. The wireless communication system according to claim 1, wherein the moving information of each of the self-propelled apparatuses comprises a position message, a speed message, a direction message, and the number of forwarding times of the moving information.

3. The wireless communication system according to claim 2, wherein if the number of forwarding times of the moving information of another self-propelled apparatus received by the at least one of the self-propelled apparatuses reaches a reference number of times, the at least one of the self-propelled apparatuses does not forward the received moving information of the another self-propelled apparatus.

4. The wireless communication system according to claim 2, wherein if the number of forwarding times of the moving information of another self-propelled apparatus received by the at least one of the self-propelled apparatuses does not reach a reference number of times, the at least one of the self-propelled apparatuses updates the number of forwarding times of the received moving information of the another self-propelled apparatus and forwards the updated moving information.

5. The wireless communication system according to claim 1, further comprising:
at least one wireless access point configured to receive the moving information of each of the self-propelled apparatuses and forward the received moving information of each of the self-propelled apparatuses.

6. The wireless communication system according to claim 1, wherein each of the self-propelled apparatuses calculates a distance to another self-propelled apparatus according to the respective moving information and the received moving information of the another self-propelled apparatus and adjusts a frequency of transmitting the respective moving information to the another self-propelled apparatus according to the distance.

7. A wireless communication method applied to a plurality of self-propelled apparatuses, the wireless communication method comprising:
transmitting, by each of the self-propelled apparatuses, respective moving information;
receiving, by each of the self-propelled apparatuses, the moving information of other self-propelled apparatuses in the self-propelled apparatuses; and
forwarding, by at least one of the self-propelled apparatuses, the received moving information of the other self-propelled apparatuses.

8. The wireless communication method according to claim 7, wherein the moving information of each of the self-propelled apparatuses comprises a position message, a speed message, a direction message, and the number of forwarding times of the moving information.

9. The wireless communication method according to claim 8, further comprising:
determining, by the at least one self-propelled apparatus, whether the number of forwarding times of the received moving information of another self-propelled apparatus reaches a reference number of times;
if the number of forwarding times of the received moving information of another self-propelled apparatus reaches the reference number of times, not forwarding, by the at least one self-propelled apparatus, the received moving information of the another self-propelled apparatus.

10. The wireless communication method according to claim 9, wherein the step of forwarding, by the at least one of the self-propelled apparatuses, the received moving information of the another self-propelled apparatus comprises:
if the number of forwarding times of the received moving information of the another self-propelled apparatus does not reach the reference number of times, updating, by the at least one self-propelled apparatus, the number of forwarding times in the received moving information of the another self-propelled apparatus and forwarding the updated moving information.

11. The wireless communication method according to claim 7, further comprising:
receiving the moving information of each of the self-propelled apparatuses through at least one wireless access point and forwarding the received moving information of each of the self-propelled apparatuses.

12. The wireless communication method according to claim 7, further comprising:
calculating, by each of the self-propelled apparatuses, a distance to another self-propelled apparatus according to the respective moving information and the received moving information of the another self-propelled apparatus; and
adjusting, by each of the self-propelled apparatuses, a frequency of transmitting the respective moving information to the another self-propelled apparatus according to the distance.

13. A self-propelled apparatus, comprising:
a wireless communication module; and
a control circuit coupled to the wireless communication module, configured to receive moving information of another self-propelled apparatus through the wireless communication module, forwarding the received moving information of the another self-propelled apparatus through the wireless communication module.

14. The self-propelled apparatus according to claim 13, wherein the moving information comprises a position message, a speed message, a direction message, and the number of forwarding times of the moving information.

15. The self-propelled apparatus according to claim 14, wherein if the number of forwarding times of the received moving information of the another self-propelled apparatus reaches a reference number of times, the control circuit does not forward the received moving information of the another self-propelled apparatus.

16. The self-propelled apparatus according to claim 14, wherein if the number of forwarding times of the received moving information of the another self-propelled apparatus does not reach a reference number of times, the control circuit updates the number of forwarding times in the moving information and forwards the updated moving information through the wireless communication module.

17. The self-propelled apparatus according to claim 13, wherein the control circuit further transmits moving information of the self-propelled apparatus through the wireless communication module, calculates a distance between the self-propelled apparatus and the another self-propelled apparatus according to the moving information of the self-propelled apparatus and the received moving information of the another self-propelled apparatus, and adjusts a frequency of transmitting the moving information of the self-propelled apparatus to the another self-propelled apparatus according to the distance.
